(19) United States
(12) Patent Application Publication
(10) Pub. No.: US 2006/0267745 A1
(43) Pub. Date: Nov. 30, 2006

(54) Vehicle visual assist

(76) Inventor: Dale Larson, Duluth, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/136,258

(22) Filed: May 24, 2005

(51) Int. Cl. G08B 21/00

(52) U.S. Cl. 340/431

(57) ABSTRACT

This invention is to a system whereby a vehicle can backup to a desired location with the assistance of a visual indicator, such as when a truck backs up to connect to a trailer or a semi-trailer backs up to a loading dock. The system uses one or more light sources to project against a target.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to a visual assist system for use in guiding a vehicle back to connect to a trailer, or to back up a vehicle to a loading dock.

Presently, when a driver needs to connect a vehicle to a trailer, the trailer may either be pulled up to the trailer hitch ball or the vehicle may be backed up to the trailer. With almost all trailers, the weight is high enough to make it difficult to move the trailer to the vehicle. Therefore, in many cases, the vehicle must be backed up to the trailer. This necessitates accurate positioning since a minor misalignment means the vehicle must be completely repositioned. Also, since the trailer tongue will not be visible to the driver, it is possible to drive the vehicle body into the trailer tongue, damaging both vehicle and trailer.

One solution is to have a passenger, if available, to help guide the driver backwards. However, this not only assumes a second qualified helper, but requires coordination between the two. This can be quite confusing since the driver is doing everything opposite to the helper. It also may create danger to the helper, especially if lighting is poor.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. § 1.56(a) exists.

### BRIEF SUMMARY OF THE INVENTION

The invention provides a reliable system for vehicles to safely and accurately back up to attach to a trailer. It also provides a system to accurately backup and stop exactly where desired at loading docks. The invention provides one or more light beam emitting devices on the vehicle that are aimed to a focal point on the trailer or other object. With two or more beams, they may be set to intersect exactly at the point in which the trailer tongue would be exactly positioned with the hitch ball on the vehicle. A single beam may be used to project a single beam onto a target placed on the trailer, which, when the distance is right, will cause the target and beam to exactly coincide.

In one form, 3 light beams, such as a laser, project an image onto an object (i.e. trailer, camper, loading dock, etc.) to visually assist a driver's depth perception. The two outside beams would cross the middle beam to create a focal point on the object being projected, which then would create a single projected image. When you move the light source away from the object, (the beam angles being fixed) the object being projected will then show three images. The two outside images would move away from the center image as the lights are moved away from the target. When lights are moved closer to the target the outside images will move to the center image until it once again becomes one image which is your set target distance. As long as the beam angles remain fixed, the distance to the target object is also fixed. Outside beam angles would be adjustable to provide for different focal points to set different target distances.

Judging target distance by using one beam you could use two horizontal strips of tape placed on the target object so when the image is projected falls between the two target tapes it would then be you set target distance. The operator would have to place the target tapes on the target based on the image size being projected at the target distance desired.

Generally, for forms with two outside beams, the control may be by the vehicle's current side mirror control. It would have two buttons near the mirror control to turn the device on. Each button would turn on a different focal point and project a different center focal image to distinguish between the two. (i.e. Focal point one would have a logo inside of a circle and focal point two would have a logo inside a square. The target object would also have a decal of a circle or a square to avoid confusion.) A simple A-B-C switch (A left side mirror, B right side mirror, C beam control) to switch the side mirror control over to the beam control may be used. Both outside beams would move in sync when adjusting the focal point up and down the center beam. The operator would only have to move the toggle in or out (left or right) to change the beams focal point. It would also be possible to raise and lower the beams as well by moving the toggle up or down. The device could also use a lockout feature so the beams would only engage when the vehicle is in reverse or in park to allow the operator to create a new focal point. (C switch must be selected and reset switch engaged). The reset switch would make it impossible to accidentally move the focal point once it is set. The light beams would also be controlled by a timer (i.e. 15 or 30 seconds).

The most critical need for the device is in the last 6 feet of the target. The operator would need to turn the device back on to reset the timer if needed. An optical device that senses outside light that would adjust the strength of the light beams may be used.

The simplest application would allow the operator to set (by hand) the focal point once for one specific application. The device could still be used on different objects by placing target decals on the object at the focal point distance that is required. (i.e. instead of having a focal point of one image, it would show three images. Just place the target decals on the object at those focal images). An aftermarket product may also be provided with built in redundancy, such as six beams, A and B). This would allow the user to select focal points of preset positions.

The invention may also be used to help back up to a loading dock or other site, either for a conventional vehicle or for semi-trailers. For semi-trailers, the lasers would be set once at the point of install so the beams focal point would be set at the end of the trailer or one foot behind. Top, bottom and middle lasers would be (hand) adjustable to change the focal point if desired. There would be no need for multiple adjustments since the purpose is to judge the rear of the trailer from the loading dock wall. There could be timer feature on this as well. To make this a simple install, a portable wireless control may be used to turn the device on. It could have a unique sending code to turn on the device thus eliminating accidentally turning on a nearby unit. This would make it easy for the control to be transferred to a different semi cab if needed. The control should stay with the trailer. A set switch may also be on the device itself. This would allow the operator to create a new focal point and temporally override the lockout feature. One could build a redundancy feature on this as well.

### BRIEF DESCRIPTION OF THE DRAWINGS

A detailed description of the invention is hereafter described with specific reference being made to the drawings in which:

FIG. 1 is a top view of a vehicle and trailer with the inventive visual assist system;

FIG. 2 is a side view of the vehicle and trailer of FIG. 1 with the system light beams shown;

FIG. 3 is a top view similar to FIG. 1 showing the vehicle backed up as desired by the aid of visual assist system;

FIG. 4 is a side view of the vehicle as in FIG. 3 which has been guided to the trailer;

FIG. 5 is a top view similar to FIG. 3 with the trailer hitch now successfully aligned and coupled;

FIG. 6 is a side view of the coupled trailer and vehicle of FIG. 5;

FIG. 7 is a top view of an alternative embodiment of the visual assist system;

FIG. 8 is a depiction of various beam arrangements that may be projected on a trailer; and

FIG. 9 depicts various view sets of light combinations on a target.

### DETAILED DESCRIPTION OF THE INVENTION

With reference to the figures, a typical vehicle 10 is shown that will be used to pull a trailer 12. Although depicted as a pickup truck, vehicle 10 may be any vehicle that is equipped to connect to a trailer. Likewise, the recreational vehicle trailer shown is exemplary of a trailer 12 only, and any trailer may be used with this invention. Use of the word trailer herein refers to any wheeled vehicle that is towed by a powered vehicle.

Typically, the trailer 12 will have a trailer tongue 14 and a trailer hitch socket 16 that interfaces with and connects to a trailer hitch ball 22 of a vehicle's trailer hitch 20. Again, the connection between the vehicle 10 and the trailer 12 is exemplary only, and any other connections that may be made may be used with the invention herein. The invention simply provides the user with the ability to backup accurately and safely to make whatever connection type exists between the vehicle 10 and the trailer 12.

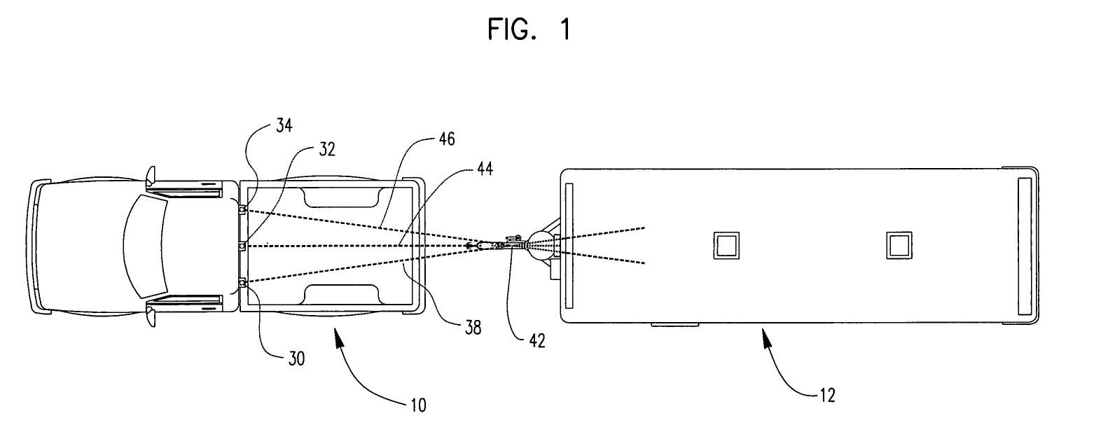

FIG. 1 shows the vehicle 10 separated from the trailer 12. As depicted, there are three spaced light sources 30, 32 and 34 on the vehicle 12 mounted such that their beamed light projects back toward the trailer 12. Light source 30 and 34 are aimed such that their projecting light beams 38, 40 intersect at a focal point 42. The light source 32 is depicted as being centrally located. Light source 32 is advantageously used to provide a constant center light beam 44 that goes directly in line with the trailer hitch ball 22.

It will be seen that the focal point 42 of left and right beams 38, 40 may be positioned such that it would be directly on the trailer 12 when the trailer is hitched to the vehicle 10. A target device 48 may be attached to the trailer 12 to provide better visibility of the beams 38, 40 and 44 as they hit the trailer 12 if desired. While shown attached to a front wall of the trailer 12, it may be attached directly to the trailer tongue 14. The target device 48 may have side walls to create a shielded enclosure such that in bright ambient light conditions the three beams will be more visible at the target 48.

When backing up the vehicle 10 toward the trailer 12, the center beam 44, if present, provides a constant reference point toward which the vehicle needs to be aimed. The left and right beams 38, 40 would initially be projected on the trailer 12 as diverse light points that will get closer together as the vehicle is being backed toward the trailer 12. When the vehicle is positioned exactly where desired the left and right beams 38, 40 will hit the trailer 12 at the focal point 42 and appear as a single light point. If a center beam 44 is used, all three light beams would converge into a single point.

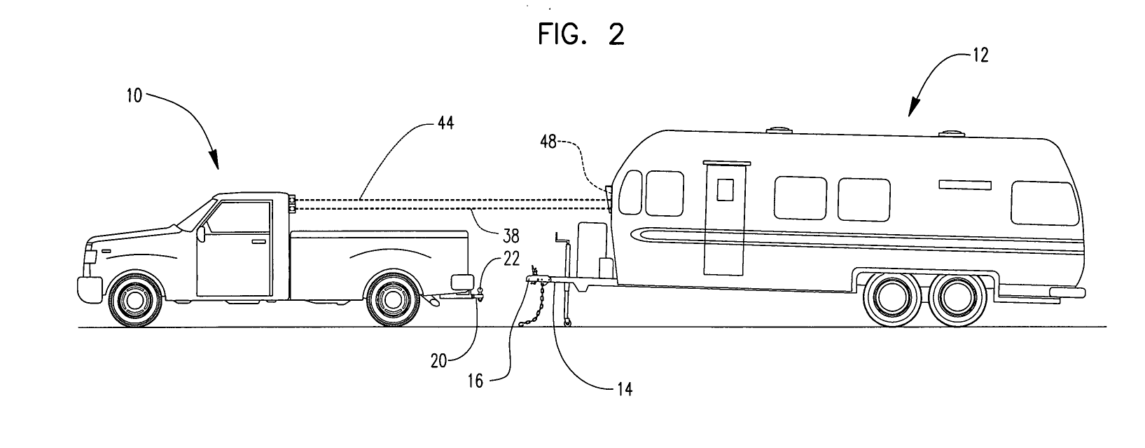

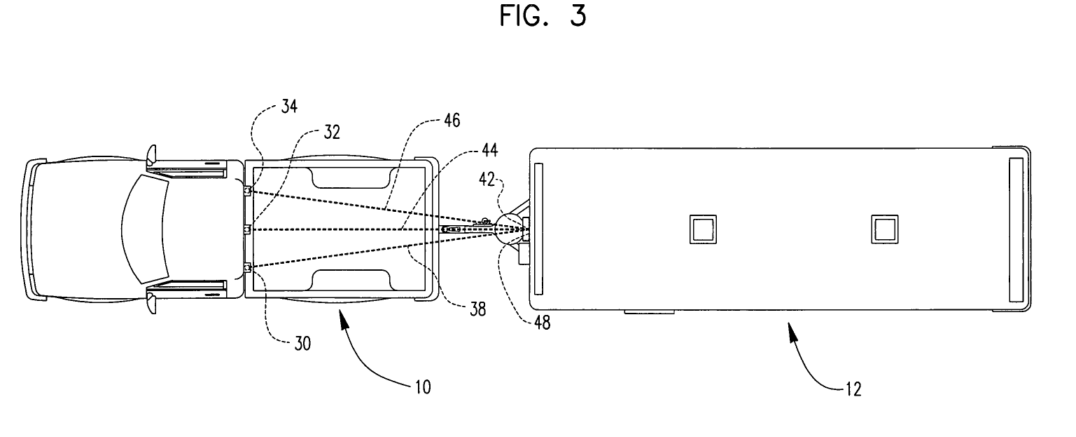

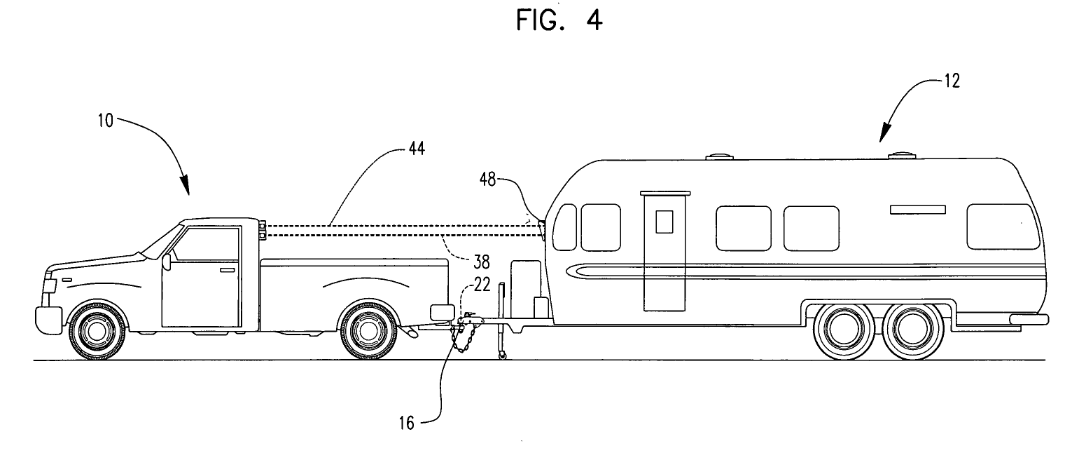

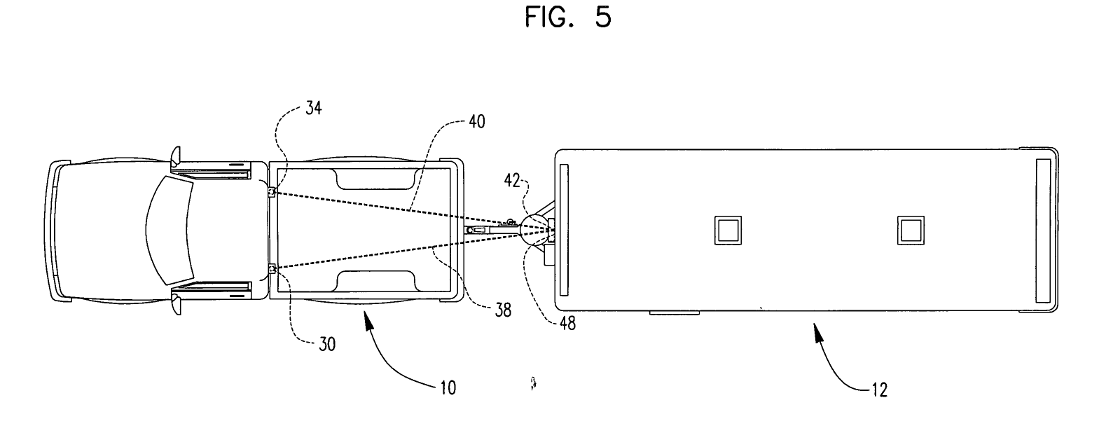

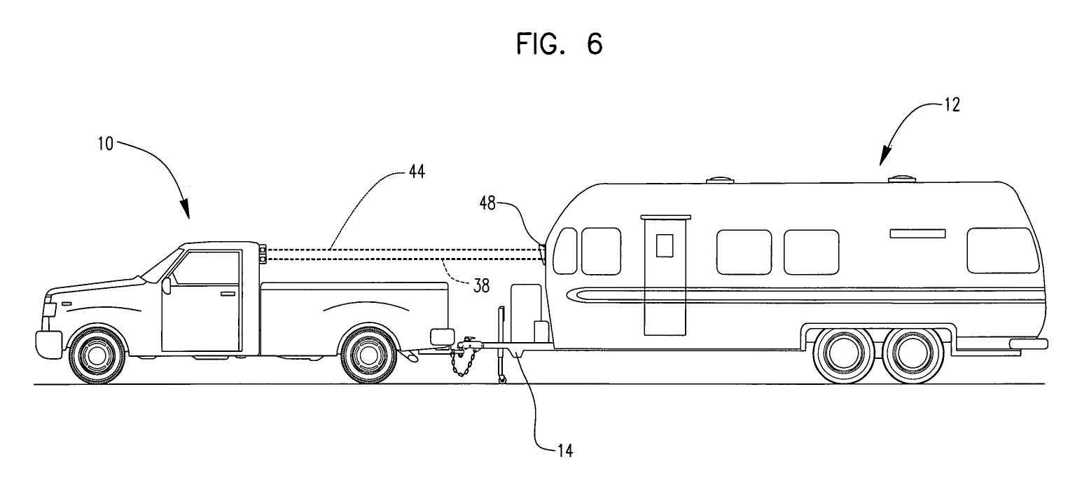

FIG. 2 shows a side view of the vehicle 10 and trailer 12 with the vehicle 10 being backed up. FIGS. 3 and 4 shows the vehicle backed up to exactly the point in which the trailer 12 may be coupled. Note that the trailer hitch socket 16 is exactly above the trailer hitch ball 22 so that it may be accurately and safely lowered onto the ball for a good connection. FIGS. 5 and 6 shows the vehicle 10 coupled to the trailer 12. Note that in FIGS. 5 and 6 that the center beam 44 is not used.

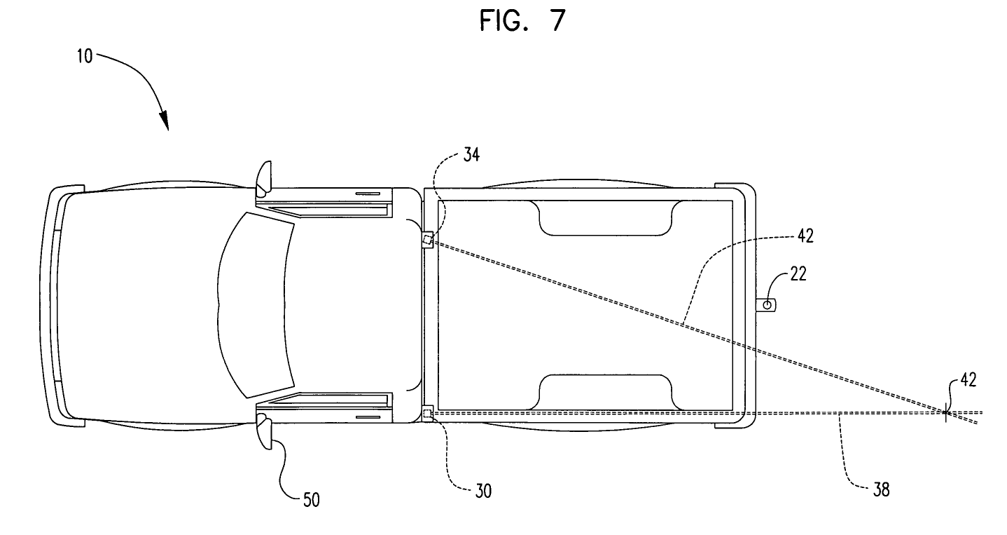

FIG. 7 shows that left light 30 and right light 32 may have there beams meet at a focal point 42 that is not directly in line with the trailer tongue 14 or trailer hitch ball 22. In this configuration, the focal point would be directly in view of a vehicle's side mirror 50. In this form a target device 48 would probably be required for many trailers since the trailer may not otherwise have a surface on which the light beams 38, 40 would project.

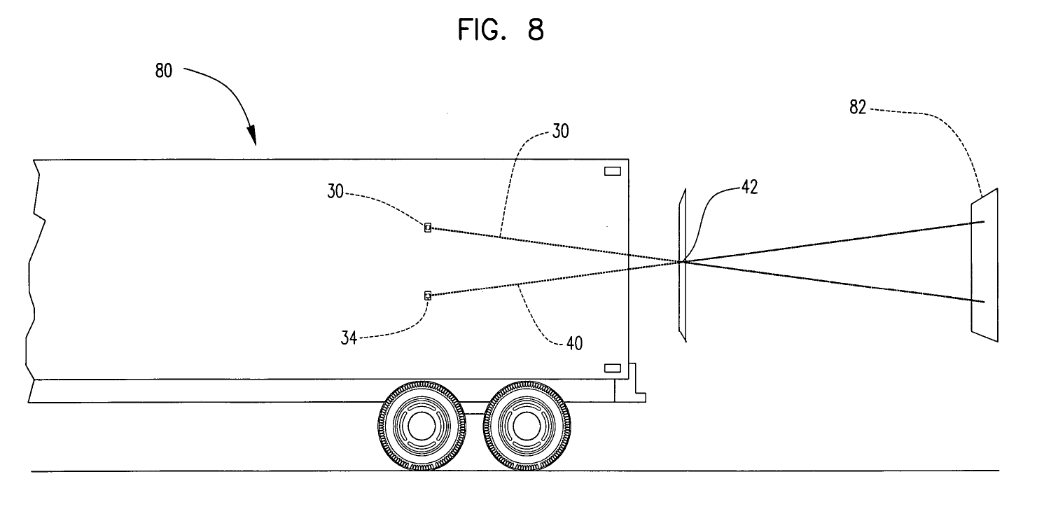

FIG. 8 shows that the invention may be placed directly on a vehicle or trailer to project light beams to a fixed site, such as a loading dock. As depicted, a semi-trailer 80 has two or more lights 30, 34 along the side of the semi-trailer 80 and directed backwardly toward the loading dock which is depicted simply as a target 82. The focal point 42 of the two beams 38, 40 may be set to the distance required between the dock target 82 and the back of the semi-trailer 80 such that when the two beams converge into the desired indicator the trailer is backed up exactly where desired. The semi-trailer version of the invention would likely involve placement of the lights of the driver's side only such that they could be best seen. The lights 30, 34 and, if used, 32, could be adjustable such that the driver could set them according to the different loading docks.

Since the back of the semi-trailer would always be the same, a unit for semi-trailers may not need to be adjustable except to the extent that the loading docks may vary. It is contemplated that a portable wireless remote control could be used to turn on the lights. If desired, the control could also have unique sending codes to ensure that a different semi-trailer's unit was not being activated. Set switches may be on the controls to allow the user to create new focal points. It is expected that the lights on the semi-trailer 80 would stay with the trailer, but portable units that attach easily, such as by magnets may be employed.

The lights 30, 32 and 34 of the invention project light toward the trailer. It is contemplated that any suitable light source that may project light may be used, with a laser being a suitable tight beam and high intensity light source. Conventional light bulbs may be employed so long as they are configured to direct a beam of light. Note that the lights may be placed anywhere on the vehicle that allows the light beams to be projected where desired. They may be on the vehicle itself or on an attachment to the vehicle, such as on a pickup topper.

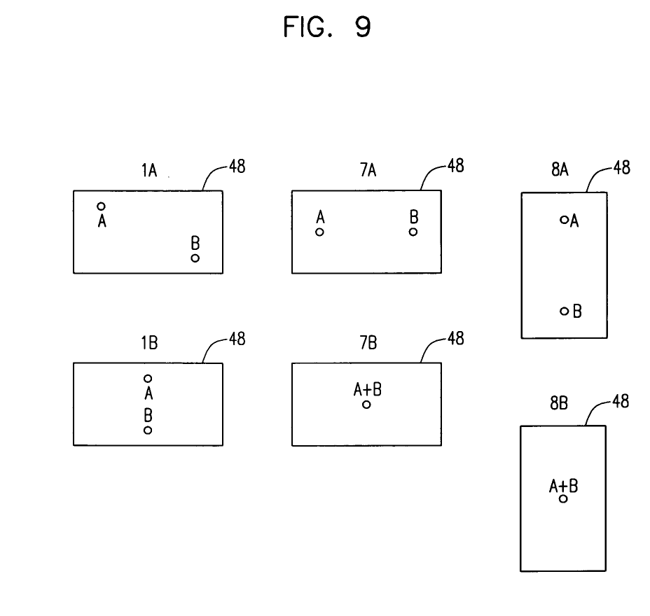

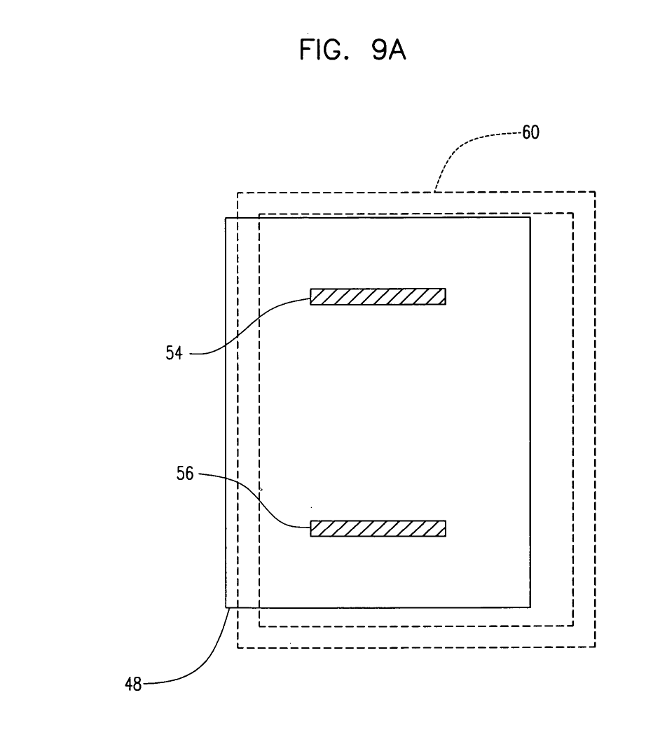

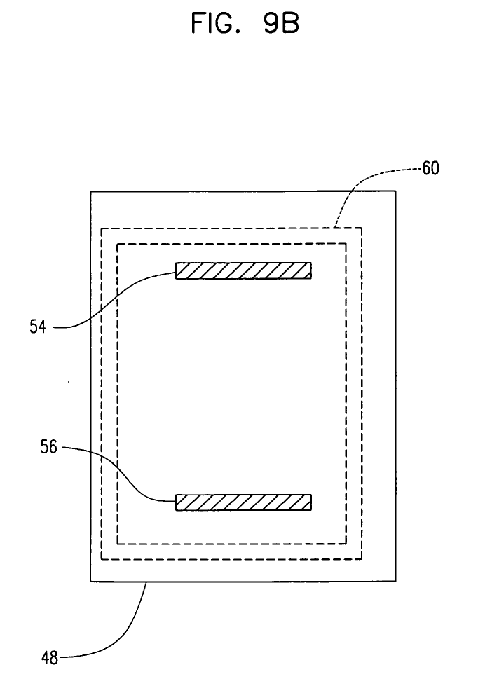

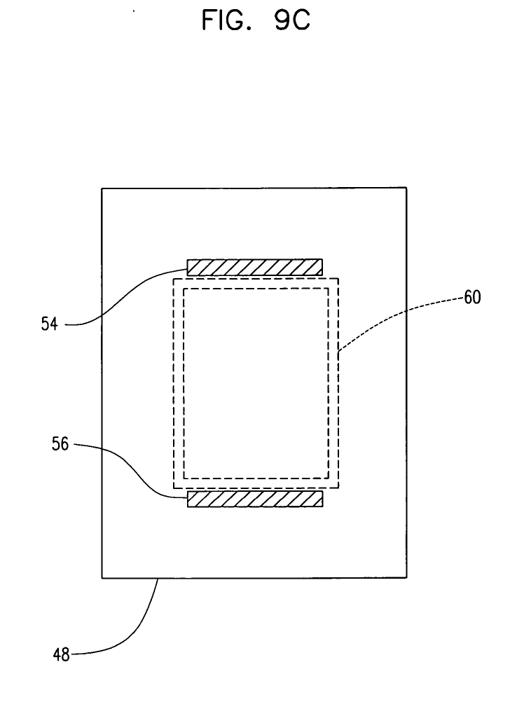

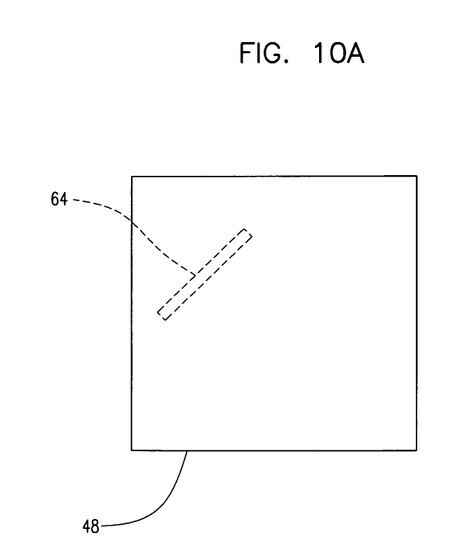

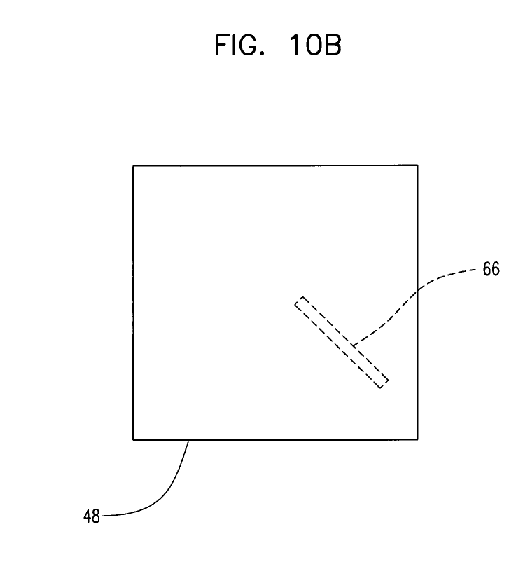

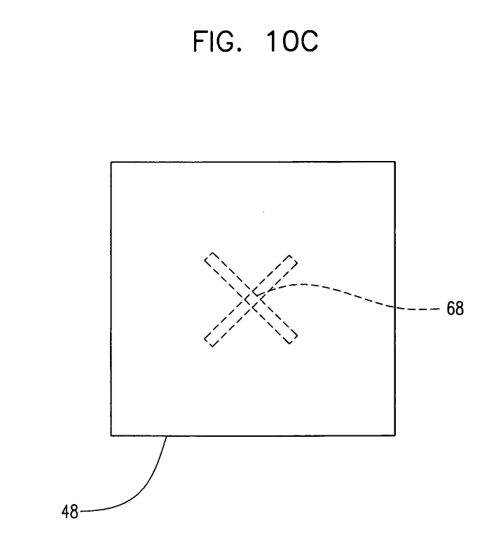

The invention may also use a single center light 32 which could be constructed to project a beam that would project a square light onto the trailer 12. FIG. 9 shows views 9A, 9B and 9C in which two target lines 54, 56 are placed on the trailer 12, such as with horizontal strips of tape. The square light beam 60 from center light 32 would project a larger square of light onto the trailer when the vehicle 10 is farther from the trailer, and hence the square light would be outside of the target lines 54, 56 as shown in view 9A. A the vehicle 10 is backed up, the square light beam 60 becomes nearly aligned with lines 54, 56 in view 9B, and is perfectly aligned with lines 54, 56 as desired in view 9C. The projected light from center light source 32 when used as the sole light source would therefore have an outwardly divergent beam. The user would connect the trailer and vehicle and would then simply place the tape to make the target lines 54, 56 on the trailer to indicate the exact alignment. This single light source could easily be used with different trailers that would each have a different focal point since the user would merely need to set up the lines 54, 56 once.

FIG. 9 shows views 10A, 10B and 10C that shows that the projected light by be in the form of bars 64, 66, rather than a point source, and alignment could be made by having the focal point, and correct alignment, be the intersection of the bars 64, 66 into a cross 68.

FIG. 9 also depicts through sets of views 1A, 1B, 7A, 7B and 8A, 8B that the light beams 38, 40 may be initially separated and appearing as points A and B on the trailer 12 in a variety of different configurations such that the focal point 42 showing alignment of the trailer 12 to the vehicle 10 need not present a single light point. View 1A shows that the left light beam and right light beam may be one above the other such that alignment creates a vertically aligned pair of light points as shown in view 1B. Views 7A and 7B show the light beams 38, 40 being set such that alignment creates a single light point with the lights moving toward each other while backing up horizontally. Views 8A and 8B shows the opposite to views 7A, 7B, in which the two light beams 38, 40 are initially above each other and then converge into a single point.

Obviously, any combination of light beams may be employed and they may have a number of different patterns so long as they help the user back up the vehicle to the desired point where the trailer hitch socket 16 is directly over the trailer hitch ball 22.

The left and right light sources 30, 34 may be very simple and be installed and aimed to a fixed point. More advantageously, they may be mounted in a manner that they may be adjusted to change the distance from the lights to their focal point. This is an advantage since a variety of different trailers to be pulled may be used, and each may have a different tongue length or distance between where the light beams will hit on the trailer or target device 48.

The lights 30, 34 may be controlled by buttons, such as by a mirror control on the vehicle to either allow an infinite number of set focal points by moving the beams or to select between a number of common distances as presets. It may also be desirable for the vehicle manufacture to build in safety features that would only allow the lights 30, 32 and 34 to be on when the vehicle is in reverse gear or in park.

For existing vehicles, an aftermarket application of the invention would include in its simplest form one to three light sources that could be battery powered that would be attachable on the vehicle per a template to provide proper placement. It could have adjustable light sources to allow the user to adjust to a desired focal point length or may have several preset focal points that could be selected by the user.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

This completes the description of the preferred and alternate embodiments of the invention. Those skilled in the art may recognize other equivalents to the specific embodiment described herein which equivalents are intended to be encompassed by the claims attached hereto.

1. A trailer hitch alignment system comprising:
at least two separated light sources mountable on a tow vehicle and capable of projecting intersecting beams of light to a set focal point which focal point is adjustable such that the focal point may be set to the distance between the vehicle and a trailer to be coupled to the vehicle so the focal point of said light beams is on said trailer when said trailer is coupled to said tow vehicle.

2. The trailer hitch alignment system of claim 1 including three separate light sources, one of which is mountable to project its light beam directly in line with a hitch of said tow vehicle.

3. The trailer hitch alignment system of claim 2 wherein said light sources which are not mountable to said vehicle to provide intersecting light beams are constructed and arranged such that the light sources may be adjusted so their projected beams intersect at a focal point at a different length from said vehicle.

4. The trailer hitch alignment system of claim 3 further including a target device capable of being secured to a trailer upon which light from said light sources may be projected.

5. The trailer hitch alignment system of claim 4 wherein said target device is constructed and arranged to provide light shielding to make said light beams more visible on said target device in high ambient light conditions.

6. A trailer hitch alignment system comprising:
a) a light source mountable on a tow vehicle which projects light out in at least three separate points, at least two of said separate points being formed by light beams from said light source that are not parallel to the other said separate points; and
b) a target device mountable to a trailer including indicia which may be positioned such that the indicia are aligned with projected light from said light source when said tow vehicle is coupled to said trailer.

7. The trailer hitch alignment system of claim 6 wherein said light source projects light outwardly to define a two dimensional shape.

8. The trailer hitch alignment system of claim 7 wherein said light source projects light outwardly in the shape of a rectangle, with the rectangle being larger the further the light is from the light source.

9. A trailer hitch alignment system comprising:
a) a vehicle having a front end and a back end, said back end including a trailer hitch mechanism for coupling to a trailer; and
b) at least two separated light sources mounted to said vehicle and capable of projecting intersecting beams of light to a set focal point which focal point is adjustable such that the focal point may be set to the distance between the vehicle and a trailer to be coupled to the vehicle so the focal point of said light beams is on said trailer when said trailer is coupled to said tow vehicle.

10. A vehicle backup system comprising:
at least two separated light sources mountable to a trailer and capable of projecting intersecting beams of light to a set focal point which is a point beyond a back end of said trailer such that said separated light sources may be directed onto a target and the distance to said target from the back of said trailer may be determined by observing the separation of the light beams on the target while backing up the trailer.

11. The vehicle backup system of claim 10 further including a loading dock target device mountable to or adjacent to a loading dock such that said light beams from said trailer may be directed upon said target device.

12. The vehicle backup system of claim 11 further including a remote control unit for controlling said light sources.
